(19) United States
(12) Patent Application Publication
(10) Pub. No.: US 2012/0247606 A1
(43) Pub. Date: Oct. 4, 2012

(54) Low-Molybdenum, High-Strength Low-Alloy 80 ksi Steel Plates Formed by Temperature-Controlled Rolling Without Accelerated Cooling

(76) Inventor: Amar K. De, Munster, IN (US)

(21) Appl. No.: 13/437,452

(22) Filed: Apr. 2, 2012

Related U.S. Application Data
(60) Provisional application No. 61/516,265, filed on Apr. 1, 2011.

(51) Int. Cl. F16L 9/00; C22C 38/12; B21D 3/00; C22C 38/04

(52) U.S. Cl. 138/177; 420/120; 420/124; 72/367.1

(57) ABSTRACT

Steel alloy, and plate formed from a low-molybdenum, high-strength, low-alloy steel, said steel alloy consisting essentially of, in wt. %: C: 0.05-0.07; Mn: 1.5-1.7; Ti: 0.01-0.025; Al: 0.02-0.04; Nb: 0.075-0.1; P: ≦0.01; S: ≦0.003; Mo: 0.1-0.2; and the remainder Fe and inevitable impurities. The plate is produced by rolling from a slab without the use of accelerated cooling.

### CROSS-REFERENCE TO RELATED APPLICATIONS

This application claims the benefit under 35 U.S.C. 119(e) of U.S. Provisional Application No. 61/516,265 filed Apr. 1, 2011.

### FIELD OF THE INVENTION

The present invention relates to plate steels, and more specifically to plate steels to be formed into structural components in equipments and also longitudinally welded steel pipe. Most specifically the invention relates to plate steel that meets 80 ksi yield strength with excellent toughness and is produced by temperature controlled rolling, without the use of accelerated cooling.

### BACKGROUND OF THE INVENTION

The advent of thermo-mechanical processing of high-strength-low-alloy (HSLA) steels has been a blessing to plate metallurgists in developing cost effective higher strength plates. Traditionally the focus of development has been the linepipe sector due to the ever increasing demand for higher strength/higher toughness plates for manufacturing of large diameter pipes for oil and gas transmission, but when the advantages of non-heat-treated (as-rolled) high strength plates for various structural type applications were realized, new areas of development could be explored. Substitution of as-rolled plates for heat treated ones presents numerous advantages to fabricators, such as better surface finish, improved flatness, more formability, and welding without pre-heating, to name a few. Additional significant benefits are lower material and fabrication costs and an improved final product.

From the perspective of metallurgy, the most effective processing method for producing 550 MPa and greater yield strength discreet rolled plates with lean chemical composition is controlled rolling paired with accelerated cooling. Controlled rolling of austenite is aimed at conditioning the austenite by working in the unrecrystallized region to the maximum extent for making the greatest surface area available for later transformation. For almost all Thermo-Mechanical Controlled Processing (TMCP) grades, there is universal unanimity in the primary processing approach for austenite conditioning. Usually, thermo-mechanical controlled processing (TMCP) consists of “temperature-controlled rolling” followed by accelerated cooling with application of water as quickly as possible after completion of rolling. It is the later controlled cooling part that often makes it difficult for plate mills to produce thinner plates (<=16 mm) with acceptable flatness and shape. Thinner plates after accelerated cooling and hot leveling may buckle during cooling on the plate cooling bed. Re-leveling in the cold condition is not desirable as it not only takes a toll on the productivity of the mill but it induces residual stresses which will result in increased potential springback and other distortions when the plate is sectioned.

The ArcelorMittal USA Burns Harbor 160″ Plate Mill (BH Plate) finds itself in an advantageous position of being able to roll wider plates up to 150″ (3810 mm) wide so that pipes of up to 48″ (1220 mm) diameter can be produced from these plates. However, on the finishing end of BH Plate, the finish rolled plate has to traverse about 60 m before it enters the accelerated cooling unit and this causes a significant temperature difference between the front and tail ends of the plate as it enters the accelerated cooling unit. The temperature drop and difference are problematic when rolling thinner and wider plates as temperature dissipation is faster. As a result, shape distortions occur due to differential thermal stresses resulting from non-uniform cooling. This causes a significant production related issue for the mill.

Thus, to keep pace with market indications for substantial future requirements of as-rolled structural plates with higher strengths 80 ksi) and also higher strength linepipe plates there is a need in the art for an alloy design together with a disciplined TMCP practice to produce high strength structural plates without the use of accelerated cooling. The said plate can also meet the need for higher strength API X80 grade plate steels. There has been increased market demand for higher strength linepipe steels for use in long distance pipelines allowing oil and gas to be transported at higher operating pressures. Many of the planned future pipeline projects such as the Alaskan Natural Gas Pipeline forecast use of large diameter high strength, high toughness pipes. Large diameter, higher strength pipelines are preferred for reduction in overall material weight, transportation and field construction costs. Though spiral welded pipes are finding increased acceptance in the construction of large diameter pipelines, longitudinally welded large diameter pipes are preferred for increased pipeline integrity and safety. To fill this need, a product development program was undertaken by the present inventor for the production of as-rolled 80 ksi plates without the use of accelerated cooling.

### SUMMARY OF THE INVENTION

The present invention relates to a steel alloy, steel plate formed from the alloy, and a longitudinally welded pipe formed from the steel plate. The steel alloy is a low-molybdenum, high-strength, low-alloy steel, said steel alloy consisting essentially of, in wt. %: C: 0.05-0.07; Mn: 1.5-1.7; Ti: 0.01-0.025; Al: 0.02-0.04; Nb: 0.075-0.1; P: ≦0.01; S: ≦0.003; Mo: 0.1-0.2; and the remainder Fe and inevitable impurities. The plate is produced by rolling from a slab without the use of accelerated cooling.

The steel plate meets 80 ksi and more in yield strength and is between 6 and 16 mm thick. The plate is produced by heating and soaking a slab of the steel composition up to 1230° C.; starting finishing rolling of said slab at a temperature of between 970-1020° C.; ending finishing rolling of said steel plate at a temperature of between 675-715° C.; applying a total finishing deformation of 60-80% to form said steel plate; and cooling said steel plate without the use of accelerated cooling. The step of cooling said steel plate without the use of accelerated cooling may be ambient air cooling of said steel plate, which may provide a cooling rate of about 1-2° C./s.

Steel pipe of X80 grade may also be formed by rolling said plate into a tube and longitudinally welding the seam. The pipe may be up to 48″ OD.

### BRIEF DESCRIPTION OF THE FIGURES

FIG. 1 is a plot of Ar₃ transformation versus cooling rate for High-Mo, Low-Mo and Mo-free samples;

FIG. 2 plots the tensile and yield strengths in MPa versus plate thickness for High-Mo, Low-Mo and Mo-free plate samples indicating that the Low-Mo alloy plates of the present invention meet 80 ksi and more in yield strength;

FIG. 3 plots Stress in MPa versus Strain for High-Mo, Low-Mo and Mo-free alloy samples;

FIG. 4 is a comparison of CVN impact energies in Joules versus temperature in ° C. for various temperatures for High-Mo, Low-Mo and Mo-free plate samples; and

FIG. 5 shows the appearance of front and side faces of 11.5 mm thick plates after a ½t bend for High-Mo, Low-Mo and Mo-free plate samples.

### DETAILED DESCRIPTION OF THE INVENTION

The present inventor proposed an alloy design together with a disciplined TMCP practice to produce high strength plates suitable for structural applications and also linepipe. The proposed chemistry and processing design allows for the production of thinner gauge 80 ksi yield strength as-rolled plates without the use of accelerated cooling employing only controlled processing conditions.

Accelerated cooling lowers the Ar₃ temperature and greatly increases the number of ferrite nuclei. Additionally, intragranular nuclei for ferrite are also induced at deformation bands within deformed and unrecrystallized austenite. In the absence of accelerated cooling, therefore, one might expect much of the ferrite grain refinement to be lost. The present inventor has explored alternate processing methods such as low temperature controlled processing below Ar₃ temperature. Low temperature processing significantly increases ferrite yield strength through the introduction of dislocation substructures. The lower the temperature of finishing deformation, the higher the yield strength.

Additionally, molybdenum has been used for high strength plate development using only controlled rolling for many of its processing and metallurgical advantages, namely Mo: (i) lowers the transformation temperature thereby widening the single phase γ-region for austenite conditioning and restricting ferrite growth after transformation, leading to finer precipitates,

(ii) inhibits pearlite transformation and gives rise to bainite or acicular ferrite formation, and
(iii) increases substructure strengthening of ferrite.

The loss of reduction of the Ar3 temperature provided by accelerated cooling can be compensated for by the following two design criterion:

### 1 An Alloy Design that Significantly Lowers the Ar₃ Using the Formula

Ar₃(° C.)=910−310C−80Mn−20Cu−15Cr−55Ni−80Mo−0.35(t−8)

where, the elemental composition of the alloying elements (C, Mn, Cu, Cr, Ni, and Mo) are in wt. % and t is plate thickness in mm. Low Ar₃ suppresses grain growth of already transformed ferrite.

Both Mn and Mo act favorably in the reduction of Ar₃. Mo inhibits pearlite formation during air cooling and aids in the formation of bainite or acicular ferrite. Mo—Nb alloying also helps to retain austenite or martensite-austenite constituent within the fine elongated ferrite grains which can minimize yield strength drop during pipemaking due to the Bauschinger effect.

### (2) Extending Controlled Processing of the Deformed and Unrecrystalized Austenite Down to Intercritical Region (γ+α)

This results in significant strengthening of already transformed ferrite through the introduction of sub grains and dislocation substructures. Further, due to a widened working range, more unrecrystallized austenite is formed which increases number of ferrite nuclei and refines the grain size.

The response of Mo to controlled low temperature processing was studied with regard to microstructure and mechanical property development. An attempt has been made to explore alloy design that would facilitate microstructure and property development suitable for structural applications requiring high strength, high toughness plates and also API-X80 plates. The API-X80 specification requirements are given in Table 1.

TABLE 1
API-X80 mechanical specifications

| Yield strength MPa (kpsi) | | Tensile strength MPa (kpsi) | | Ratio YS/TS |
|---|---|---|---|---|
| Min | Max | Min | Max | Max |
| 555 (80.5) | 705 (102.3) | 625 (90.6) | 825 (119.7) | 0.93 |

The present inventor chose High-Mo, Low-Mo and Mo-free compositions to test production using controlled temperature rolling without accelerated cooling. C—Mn—Nb and C—Mn—Nb—Mo compositions were selected. The general compositions are given in Table 2 (note that the remainder of the alloy is Fe and inevitable impurities).

TABLE 2
General Steel Compositions

| Steels | C | Mn | P | S | Si | Mo | Ti | Al | Nb |
|---|---|---|---|---|---|---|---|---|---|
| Mo | 0.05-0.09 | 1.7-1.9 | <0.015 | <0.003 | 0.25-0.35 | >=0.25 | 0.01-0.025 | 0.02-0.04 | 0.075-0.1 |
| Low-Mo | 0.05-0.07 | 1.5-1.7 | <0.01 | <0.003 | 0.25-0.35 | 0.1-0.2 | 0.01-0.025 | 0.02-0.04 | 0.075-0.1 |
| Mo-Free | 0.05-0.09 | 1.7-1.9 | <0.01 | <0.003 | 0.25-0.35 | <0.003 | 0.01-0.025 | 0.02-0.04 | 0.075-0.1 |

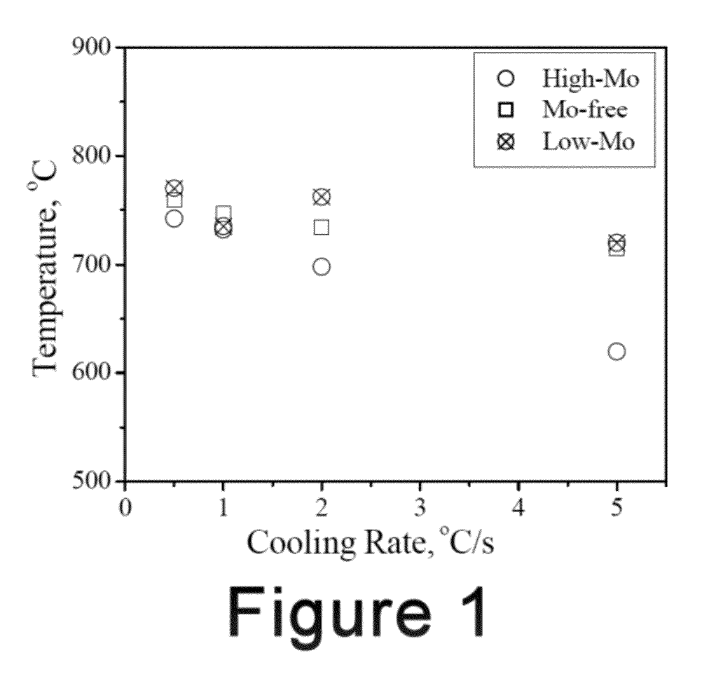

Ar₃ transformation temperatures were evaluated from dilatometry using cylindrical samples of 5 mm diameter×10 mm length. Cooling rates of 0.5, 1, 2 and 5° C./s were employed and the resulting Ar₃ transformation temperatures are shown in FIG. 1 for the three alloys ranges of Table 2. FIG. 1 is a plot of Ar₃ transformation versus cooling rate for High-Mo, Low-Mo and Mo-free samples. It can be seen from FIG. 1 that Ar₃ transformation temperature decreases with increasing cooling rate and an influence of Mo in lowering the transformation temperature is clearly indicated.

The heats were made at ArcelorMittal Indiana Harbor Plant and Ca-treated for sulfide shape control and continuously cast to slabs of 233 mm thickness. The slabs were hot rolled using controlled processing conditions given in Table 3. The plates were rolled to thicknesses of from 9.5 to 19 mm and formed without accelerated cooling.

TABLE 3
Plate Rolling Conditions

| Slab Reheat | Start Finish | End Finish | Total Finish |
|---|---|---|---|
| Temp. ° C. | Rolling Temp. ° C. | Rolling Temp. ° C. | Deformation % |
| 1230 | 970-1020 | 675-715 | 60-80 |

### Mechanical Properties

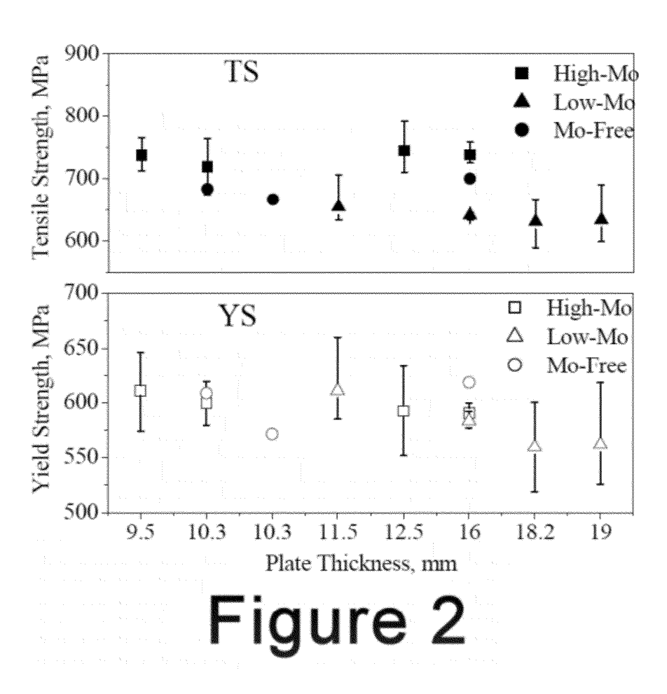

As anticipated, the mechanical properties of High-Mo alloyed steel plates met the API-X80 specification requirements, but completely unexpectedly, the Mo-free steel plates also met the API-X80 specifications. Furthermore, the Low-Mo alloyed steels (which also have reduced C and Mn) also met the API-X80 specifications, and in some regards was better than both the High-Mo and Mo-Free alloys. The mechanical properties of High-Mo, Low-Mo and Mo-free plate samples are summarized in FIGS. 2-4. Tensile properties of all three steel plates alloy ranges are shown in FIG. 2. That is, FIG. 2 plots the tensile and yield strengths in MPa versus plate thickness for High-Mo, Low-Mo and Mo-free plate samples. It is seen that for similar processing conditions, a yield strength of 550 MPa can be easily achieved for all three alloy composition ranges up to 16 mm (High-Mo and Mo-Free steels were processed only up to 16 mm thickness). Some of the Low-Mo plates were processed up to a thickness of 19 mm under similar processing conditions and average yield strength of 550 MPa could be obtained. An increase in the tensile strength was observed with increasing Mo-content. For Low-Mo steel, a moderate decrease in yield strength with increasing thickness could be seen.

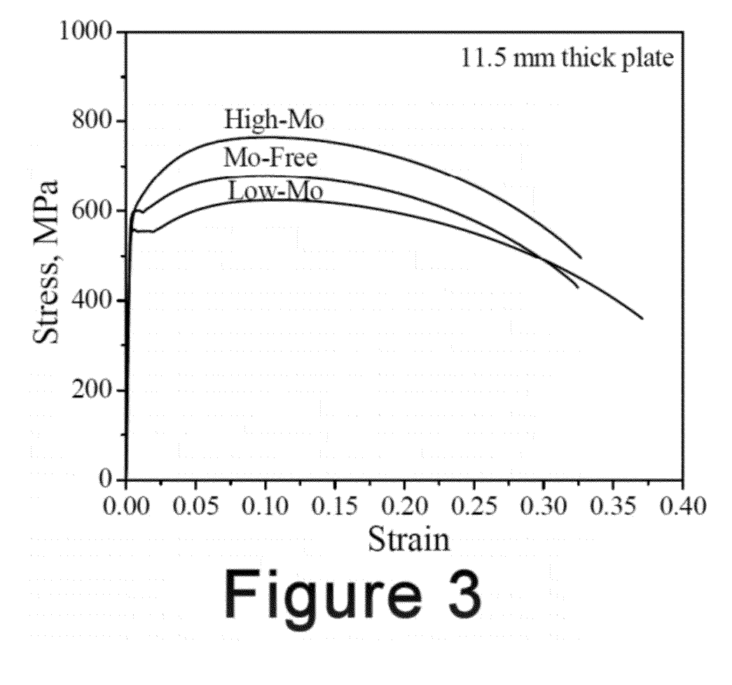

The flow behaviors of all three alloy ranges are shown in FIG. 3, which plots Stress in Mpa versus Strain. High-Mo steel manifested a continuous yielding with high strain hardening compared to the other two alloys. This behavior can be related to the microstructural features of high-Mo steel as it consisted of significant fraction of hardened

constituents such as bainite, M-A constituents and martensite in addition to deformed ferrite. The ferrite grains were also finer compared to the other two alloys. The Mo-free steel registered a yield point elongation of 1.1% in spite of considerable presence of MA constituents. The continuous yielding in high-Mo is possibly due to the combined interaction of massive bainite, M-A constituents and ferrite substructures.

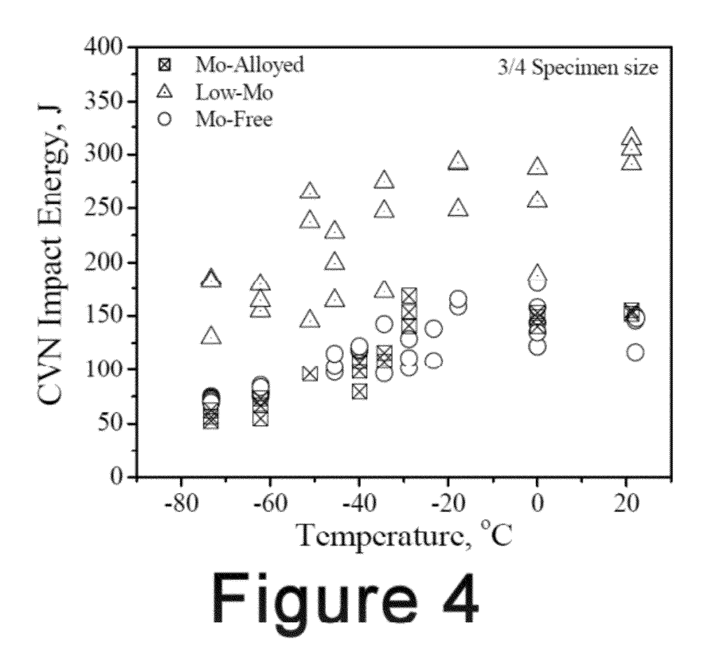

FIG. 4 is a comparison of CVN impact energies in Joules versus temperature in ° C. for various temperatures for High-Mo, Low-Mo and Mo-free plate samples. Both the high-Mo and Mo-free alloy plates revealed similar impact transition behavior. The transition from ductile to brittle is very gradual in both microstructures. An impact toughness of more than 50 J could be achieved at low temperature of −75° C. Surprisingly, the low-Mo steel indicated higher impact energy values at all test temperatures compared to the High-Mo and Mo-free steels. Excellent upper shelf energy together with a lower transition temperature was observed. The increased impact toughness is believed to due to lowering of M-A and martensite constituents and smaller bainite packet size resulting from a lower C, Mn and Mo contents. The Low-Mo alloy presents a useful alloy design to go with controlled low temperature processing where attractive high toughness can be achieved without compromising strength as compared to high-Mo and Mo-free alloy design. The high toughness is revealed even at thickness of 19 mm and the impact specimens did not reveal splitting during testing.

Higher Mo promoted significant bainite formation and substructure strengthening. Presence of appreciable fraction of M-A and martensite constituents led to a lowering of Charpy impact upper shelf energy compared to that in the low-Mo steel. Lowering of Mo together with a reduction of C and Mn contents facilitated a tougher microstructure development with strength levels similar to that obtained for high-Mo steel.

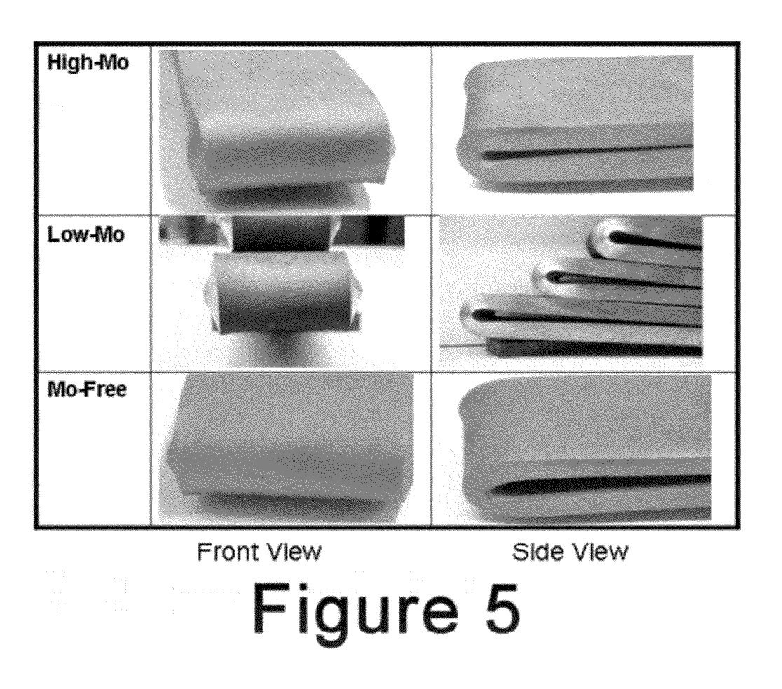

From structure-property correlations it is apparent that all three alloy designs offer attractive metallurgical and processing opportunities for the production of high strength, high toughness thinner plates through low temperature processing route. The strength-toughness combination presents an attractive package for many structural applications. Additionally, all three steels also revealed excellent bendability when bent through a ½″ radius bend at ambient temperature with bend axis transverse to rolling direction. FIG. 5 shows the appearance of front and side faces of 11.5 mm thick plates after a ½t bend. No surface cracks could be observed after the bend for any of the plate steels tested. These steels therefore, indicate significant potential opportunities for many structural applications requiring both strength and formability attributes and specifically the Low-Mo steel which offers the added advantage of increased toughness.

Plates may also be formed into longitudinally welded non-expanded pipes up to 48″ OD and the material properties after pipe forming meet API-X80 properties. As used herein, the minimum thickness that is considered a plate is about 6 mm.

It is to be understood that the disclosure set forth herein is presented in the form of detailed embodiments described for the purpose of making a full and complete disclosure of the present invention, and that such details are not to be interpreted as limiting the true scope of this invention as set forth and defined in the appended claims.

We claim:

1. A low-molybdenum, high-strength, low-alloy steel for the production of steel plates, said steel alloy consisting essentially of, in wt. %:
C: 0.05-0.07; Mn: 1.5-1.7; Ti: 0.01-0.025; Al: 0.02-0.04; Nb: 0.075-0.1; P: ≦0.01; S: ≦0.003; Mo: 0.1-0.2; and the remainder Fe and inevitable impurities.

2. A steel plate formed from a low-molybdenum, high-strength, low-alloy steel, said steel alloy consisting essentially of, in wt. %:
C: 0.05-0.07; Mn: 1.5-1.7; Ti: 0.01-0.025; Al: 0.02-0.04; Nb: 0.075-0.1; P: ≦0.01; S: ≦0.003; Mo: 0.1-0.2; and the remainder Fe and inevitable impurities.

3. The steel plate of claim 2, wherein said steel plate has an 80 ksi rating.

4. The steel plate of claim 3, wherein said steel plate is between 6 and 16 mm thick.

5. The steel plate of claim 2, wherein said steel plate is formed by the steps of:
heating and soaking a slab of the steel composition up to 1230° C.;
starting finishing rolling of said slab at a temperature of between 970-1020° C.;
ending finishing rolling of said steel plate at a temperature of between 675-715° C.;
applying a total finishing deformation of 60-80% to form said steel plate;
cooling said steel plate without the use of accelerated cooling.

6. The steel plate of claim 5, wherein said step of cooling said steel plate without the use of accelerated cooling comprises ambient air cooling of said steel plate.

7. The steel plate of claim 6, wherein said step of ambient air cooling of said steel plate provides a cooling rate of about 1-2° C./s.

8. A steel pipe, said steel pipe being formed from a steel plate, said steel plate formed of a low-molybdenum, high-strength, low-alloy steel, said steel alloy consisting essentially of, in wt. %:
C: 0.05-0.07; Mn: 1.5-1.7; Ti: 0.01-0.025; Al: 0.02-0.04; Nb: 0.075-0.1; P: ≦0.01; S: ≦0.003; Mo: 0.1-0.2; and the remainder Fe and inevitable impurities.

9. The steel pipe of claim 8, wherein said steel plate has an 80 ksi rating.

10. The steel pipe of claim 9, wherein said steel plate is between 6 and 16 mm thick.

11. The steel pipe of claim 8, wherein said steel plate is formed by the steps of:
heating and soaking a slab of the steel composition up to 1230° C.;
starting finishing rolling of said slab at a temperature of between 970-1020° C.;
ending finishing rolling of said steel plate at a temperature of between 675-715° C.;
applying a total finishing deformation of 60-80% to form said steel plate;
cooling said steel plate without the use of accelerated cooling.

12. The steel pipe of claim 11, wherein said step of cooling said steel plate without the use of accelerated cooling comprises ambient air cooling of said steel plate.

13. The steel plate of claim 12, wherein said step of ambient air cooling of said steel plate provides a cooling rate of about 1-2° C./s.

14. The steel pipe of claim 8, wherein said steel pipe is formed by rolling said plate into a tube and longitudinally welding the seam.

15. The steel pipe of claim 14, wherein said steel pipe is up to 48″ OD.
